(19) United States
(12) Patent Application Publication
(10) Pub. No.: US 2005/0273739 A1
(43) Pub. Date: Dec. 8, 2005

(54) Pattern analysis method, pattern analysis apparatus, yield calculation method and yield calculation apparatus

(75) Inventor: Yoko Tohyama, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/136,574

(22) Filed: May 25, 2005

(30) Foreign Application Priority Data
Jun. 2, 2004 (JP) 2004-164285
Dec. 15, 2004 (JP) 2004-362863

(51) Int. Cl. G06F 17/50; G06F 9/45

(52) U.S. Cl. 716/4; 716/5

(57) ABSTRACT

A critical area of one via is calculated on the basis of sizes of a plurality of vias, sizes of defects causing random defect failures of the plural vias and a distance from the one via to another adjacent via.

### CROSS-REFERENCE TO RELATED APPLICATIONS

This application claims priority under 35 U.S.C. §119 on Patent Application Nos. 2004-164285 and 2004-362863 filed in Japan respectively on Jun. 2, 2004 and Dec. 15, 2004, the entire contents of which are hereby incorporated by reference.

### BACKGROUND OF THE INVENTION

The present invention relates to a method and an apparatus for obtaining a yield of vias in an electronic device including vias such as a semiconductor device.

In the fabrication of semiconductor devices such as LSIs, the cost of the semiconductor devices can be lowered by obtaining a large number of good LSIs from one semiconductor substrate (semiconductor wafer), namely, by improving the yield. The known factors for lowering the yield are, for example, defects such as particles causing a short-circuit or open of an interconnect or causing a via formation failure in respective steps (particularly, a wiring step) of the LSI fabrication process. The density of defects such as particles can be estimated on the basis of, for example, dust distribution information of a clean room where the LSIs are fabricated. As the chip size of the LSIs is larger, the number of defects such as particles caused in one LSI chip is increased, and hence, the yield is lowered. In order to improve the yield of LSIs, it is necessary to rapidly extract a step having the factor for lowering the yield so as to provide a countermeasure early.

It is significant for estimating the fabrication cost of LSIs to calculate such a yield of LSIs at the design stage. Therefore, in a conventional technique where the yield of a new type of products of semiconductor devices such as LSIs is calculated on trial, the yield is calculated by using a model formula such as a seeds model (see Formula 1 below) or a Poisson model (see Formula 2 below) in consideration of the chip size.
Y=1/(1+A·D) Formula 1:
Y=exp(−A·D) Formula 2:

In these formulas, Y is the yield, A is a chip area (cm²) and D is a defect density (/cm²). Also, when the chip size (the chip area) is the same, the yields respectively calculated in accordance with these Formulas 1 and 2 are the same.

However, since circuits are recently complicated as a result of increase of the degree of integration and improved performance of the circuits, even when the chip sizes are the same, an equivalent yield cannot be obtained in some of different types of products. This is for the following reason: Even when the chip sizes are the same, there is a difference in probability of occurrence of defects in an interconnect forming step between, for example, a type of products with a high interconnect density and a type of products with a low interconnect density. This difference makes considerable a difference in the yield between these types.

As a countermeasure, for example, a method using, for the calculation of the yield in consideration of open or short-circuit of interconnects, a defect distribution curve and a critical area where a defect actually causes a failure has been proposed (see Non-patent document 1 below). A critical area is an index for quantitatively indicating the degree that a defect causes a short-circuit or disconnection derived from open, and is equal to a sum of areas in which a defect actually causes a failure in a chip.

On the other hand, a via chain is generally and widely used as a test chip for calculating the yield of contacts or vias for connecting interconnects in an LSI. FIG. 12A is a schematic plan view of a conventionally used via chain. As shown in FIG. 12A, the via chain includes a lower interconnect 1, an upper interconnect 2 and vias 3 for connecting them to each other. In the conventional method, the resistance of the via chain as shown in FIG. 12A is measured, so as to calculate fraction defective of the vias on the basis of the measurement result (see, for example, Patent document 1). Also, the yield of vias in an actual product can be calculated by using the thus calculated fraction defective of the vias or contacts and the total number of vias or contacts included in an actual layout in accordance with the following Formula 3:
YRV=exp(−λv·N) Formula 3:
wherein λv is the fraction defective per via or contact and N is the number (total number) of vias or contacts. It is noted that a via hole for connecting upper and lower interconnects to each other and a conductive material filled in the vial hole are herein together designated as a via. Also, a contact hole for connecting a diffusion layer or the like and an interconnect to each other and a conductive material filled in the contact hole are together designated as a contact. Furthermore, vias and contacts are herein together comprehensively designated as vias unless otherwise mentioned.

Patent Document 1: Japanese Laid-Open Patent Publication No. 61-016541

Non-patent Document 1: C. H. Stapper, Modeling of Integrated Circuit defect Sensitivities, IBM J. Res. Develop., U.S.A., November 1983, Vol. 27, pp. 549-557

Non-patent Document 2: H. Nagaishi, et al., Defect Reduction in Cu dual Damascene Process Using Short-Loop Test Structure, IEEE transactions on semiconductor manufacturing, U.S.A., August 2003, Vol. 16, no. 3

Non-patent Document 3: G. A. Allan, et al., Critical Area Extraction for Soft fault estimation, IEEE transactions on semiconductor manufacturing, U.S.A., February 1998, Vol. 11, no. 1

Non-patent Document 4: C. H. Stapper, Modeling of defects in integrated circuit photolithographic patterns, IBM J. Res. Develop., U.S.A., July 1984, Vol. 28, No. 4

Non-patent Document 5: W. A. Pleskacz, et al., A DRC-Based Algorithm for Extraction of Critical Areas for Opens in Large VLSI Circuits, IEEE transactions on computer-aided design of integrated circuits and systems, U.S.A., February 1999, vol. 18, no. 2

Non-patent Document 6: Pranab K. Nag, et al., Hierarchical Extraction of Critical Area for Shorts in Very large ICs, IEEE International Workshop on Defect and Fault Tolerance in VLSI systems, U.S.A., 1995, pp. 19-27

Non-patent Document 7: C. H. Stapper, Integrated Circuit Yield Management and Yield Analysis: Development and Implementation, IEEE Transactions on Semiconductor Manufacturing, U.S.A., May 1995, Vol. 8, No. 2, pp. 95-102

### SUMMARY OF THE INVENTION

The factors for causing via failures are classified into systematic factors derived from a via forming step and defect factors randomly occurring. An example of the systematic factors derived from the via forming step is a contact failure occurring between multilayered interconnects. Specifically, in the case where an insulating film remains below a via hole owing to a failure in forming the via hole, a lower interconnect and an upper interconnect cannot be electrically connected to each other, and hence, a contact failure is caused. When the conventional via yield calculation method using the aforementioned Formula 3 is employed, with respect to the systematic factors for via failures, the yield can be obtained rather accurately.

In the conventional via yield calculation method, however, the occurrence probability of via failures derived from randomly occurring defects (hereinafter referred to as random defect failures) cannot be accurately obtained.

Also, in the case where the via failures are calculated on the basis of the evaluation result of a test chip in a via chain shape as in the conventional method, there arises a problem that not only genuine via failures but also failures of a lower interconnect and an upper interconnect are inclusively calculated as the via failures.

Furthermore, as a factor for causing via open failures, it is necessary to consider, in addition to hard open corresponding to substantial disconnection, a phenomenon designated as soft open in which a via has a larger resistance value than a normal value although it is conductive.

In consideration of the aforementioned conventional problems, a first object of the invention is calculating a yield of vias in consideration of random defect failures, a second object thereof is calculating a genuine via yield excluding failures of a lower interconnect and an upper interconnect by using a test chip in a via chain shape, and a third object thereof is calculating a critical area and a yield with respect to soft open failures of vias separately from a critical area and a yield with respect to hard open failures of the vias.

In order to achieve the first object, namely, in order to calculate a yield of vias in consideration of random defect failures, the present inventor has devised a method and an apparatus for performing pattern analysis of a device on the basis of a noble concept of a “via critical area” in which not only the total number of vias but also distances between the vias are taken into consideration.

Specifically, according to the invention, the “via critical area” according to the newly introduced concept is obtained on the basis of the size of vias, the sizes of defects and distances from adjacent vias. When the “via critical area” is obtained, the yield of vias derived from the random defect failures can be expressed as the following Formula 4 by applying, for example, the Poisson model:
Y=exp(−Cav·D0) Formula 4:
wherein Cav is the “via critical area”, and D0 is the “total number per unit area of defects having sizes possibly causing via failures”, namely, the “defect density”.

Also, Cav·D0 of the Formula 4 can be specifically expressed as a function of the size x of a defect as the following Formula 4′:
Cav·D0=∫Cav(x)·D0(x)dx Formula 4′:
wherein D0(x) is a defect particle size distribution of the defect density generally defined as, for example, D0(x)=D0·k·x^{-P}, wherein k is a constant for making a value integrating D0(x) equal to D0, and P is a defect particle size distribution constant. Also, a value integrating D0(x) in a range from the minimum size of a defect causing a failure to the infinite size thereof is D0.

Furthermore, in order to achieve the second object, namely, in order to calculate a genuine via yield excluding failures of a lower interconnect and an upper interconnect, the present inventor has devised a method for calculating a genuine via yield by dividing a yield calculated as the yield of a via chain by yields of the lower interconnect and the upper interconnect. This will now be specifically described by exemplifying the case where a yield is calculated by using the via chain shown in FIG. 12A.

As actual open failures, an open failure of the lower interconnect or an open failure of the upper interconnect may be caused as shown in FIG. 12B separately from an open failure of the via. Accordingly, a yield Ychain of the whole via chain is expressed as the following Formula 5-1 by using, for example, the Poisson distribution model:
Ychain=Ylower×Yupper×Yvia
=exp(−(D0lower×Ecalower))
×exp(−(D0upper×Ecaupper))
×exp(−(D0via×Ecavia)) Formula 5-1:
wherein Ychain is the yield of the via chain, Ylower is the yield of the lower interconnect, Yupper is the yield of the upper interconnect, Yvia is the yield of the vias, D0lower, D0upper and D0via are respectively the density of defects causing random defect failures in the lower interconnect (hereinafter referred to as the defect density of the lower interconnect), the density of defects causing random defect failures in the upper interconnect (hereinafter referred to as the defect density of the upper interconnect) and the density of defects causing random defect failures in the vias (hereinafter referred to as the defect density of the vias), and Ecalower, Ecaupper and Ecavia are respectively the critical area of the lower interconnect, the critical area of the upper interconnect and the critical area of the vias.

The critical areas of the upper interconnect, the lower interconnect and the vias can be obtained by, for example, graphic data processing of the layout data of the via chain. Also, the defect densities of the upper interconnect and the lower interconnect can be obtained on the basis of, for example, the yields of test chips in a serpent and comb shape dedicated to the upper interconnect and the lower interconnect (see, for example, FIGS. 19 and 20 of Non-patent document 4).

Accordingly, when the yield Ychain is obtained and the yields Ylower and Yupper are obtained by using the densities D0lower and D0upper and the critical areas Ecalower and Ecaupper obtained as described above, the yield Yvia can be obtained on the basis of the following Formula 5-2 obtained by modifying the Formula 5-1:
Yvia=Ychain/(Ylower×Yupper) Formula 5-2:

Also, when the yield Yvia is calculated by the Formula 5-2, the density D0via can be obtained on the basis of the following Formula 5-3 obtained by modifying the Formula 5-1:
D0via=−In(Yvia)/Ecavia Formula 5-3:

In order to achieve the third object, namely in order to calculate a critical area and a yield with respect to soft open failures of vias separately from those with respect to hard open failures, the present inventor has devised a method in which via failures are divided into open failures and short failures and the open failures are further divided into soft open failures and hard open failures. At this point, a hard open failure means a state where a via has such high resistance that a failure is unavoidably caused in an inspection step. Also, a soft open failure means a state where a via is conductive but has a resistance value larger than a general value (normal value) and hence there is a possibility that a failure is caused owing to a problem of a circuit operation or that the increase of the via resistance leads to a problem of reliability (see, for example, Non-patent document 3).

Specifically, in order to achieve the third object, it is necessary, for calculating the yield, to classify evaluation results of a test chip into short failures, soft open failures and hard open failures. Also, in the case where a critical area is calculated on the basis of layout data of a test chip, it is necessary to obtain a short critical area, a soft open critical area and a hard open critical area separately with respect to each of an upper interconnect, a lower interconnect and vias. It is noted that any of conventionally widely used methods such as a Monte Carlo method and a geometry method can be employed for calculating a critical area. In the calculation, it is necessary to define a condition for the sizes of defects that can actually cause failures, and in addition, it is necessary to define occurrence conditions of the hard open failure and the soft open failure when these failures are distinguished from each other.

The present invention was devised on the basis of the aforementioned findings. In order to achieve the first object, the first pattern analysis method of this invention for an electronic device including a plurality of vias, includes the step of calculating a critical area of one via out of the plurality of vias on the basis of sizes of the plurality of vias, sizes of defects causing random defect failures of the plurality of vias and a distance from the one via to another adjacent via.

In the first pattern analysis method, a critical area of an arbitrary via out of a plurality of vias included in an electronic device is obtained on the basis of the size of the plural vias, the sizes of defects causing random defect failures and a distance from the arbitrary via to another adjacent via. Therefore, fraction defective of the vias with respect to random defects can be simply and accurately obtained by using the thus obtained critical areas. When the critical areas of the vias are thus used for yield calculation, a highly precise yield, namely, a yield very close to the yield of actual products, can be rapidly calculated even in a complicated pattern of an LSI with a high degree of integration.

In the first pattern analysis method, the step of calculating a critical area of one via preferably includes a sub-step of selecting the one via from the plurality of vias, calculating a distance from the one via to another adjacent via, and defining a region from the one via to a half of the calculated distance as a space region of the one via.

Thus, the critical area can be comparatively easily and rapidly calculated.

In the first pattern analysis method, the step of calculating a critical area of one via preferably includes a sub-step of selecting the one via from the plurality of vias, calculating a distance from the one via to another adjacent via in each of four regions partitioned by four half-lines starting from the one via, and defining a region from the one via to a half of the calculated distance as a space region of a quarter of the one via corresponding to each of the four regions.

Thus, a layout pattern of actual vias can be simplified, and hence, the critical area can be comparatively easily and rapidly calculated.

In order to achieve the first object, the first yield calculation method of this invention using the first pattern analysis method, includes the step of calculating a yield of the plurality of vias on the basis of the critical area obtained by the pattern analysis method and a density and a distribution of the defects previously obtained.

In the first yield calculation method, a critical area is obtained by using the first pattern analysis method of the invention, namely, a critical area of an arbitrary via out of a plurality of vias included in an electronic device is obtained on the basis of the size of the plural vias, the sizes of defects causing random defect failures and a distance from the arbitrary via to another adjacent via. Then, a yield of the vias, namely, the fraction defective of the vias with respect to the random defect failures, is calculated on the basis of the thus obtained critical areas and the density and distribution of the defects (causing the random defect failures of the vias) previously obtained. Accordingly, the fraction defective of the vias in consideration of actual random defects can be simply and accurately calculated, and hence, a highly precise yield, namely, a yield very close to the yield of actual products, can be rapidly calculated even in a complicated pattern of an LSI with a high degree of integration.

In order to achieve the first object, the second yield calculation method of this invention includes the steps of calculating critical areas of a plurality of vias included in an electronic device; and calculating a yield Y of the plurality of vias in accordance with the following formula:
Y=exp(−Cav·D0)
wherein Cav is the critical areas of the plurality of vias and D0 is a total number per unit area of defects with sizes possibly causing failures of the plurality of vias.

In the second yield calculation method, the critical areas Cav of the vias are calculated, and the yield Y of the vias is calculated by using the critical areas Cav and the total number D0 of defects with sizes possibly causing via failures in accordance with Y=exp(−Cav·D0). In other words, the fraction defective of the vias in consideration of actual random defects is simply and accurately calculated, and hence, a highly precise yield, namely, a yield very close to the yield of actual products, can be rapidly calculated even in a complicated pattern of an LSI with a high degree of integration. In this case, the step of calculating critical areas may include a sub-step of calculating a critical area of one via out of the plurality of vias on the basis of sizes of the plurality of vias, the sizes of defects possibly causing random defect failures of the plurality of vias and a distance from the one via to another adjacent via. Alternatively, the step of calculating critical areas may include a sub-step of calculating, as the critical areas of the plurality of vias, two kinds of open critical areas at least including a hard open critical area and a soft open critical area.

In order to achieve the first object, the pattern analysis apparatus of this invention includes a storage device for storing, as CAD data, mask data corresponding to pattern layout data with respect to which a critical area is to be obtained; operating means for executing the pattern analysis method of this invention by using the mask data read from the storage device; and outputting means for outputting information of the critical area obtained by the operating means.

In other words, the pattern analysis apparatus of this invention is an apparatus for executing the pattern analysis method of this invention, and therefore, the effects described with respect to the first pattern analysis method can be attained.

In order to achieve the first object, the yield calculation apparatus of this invention includes a storage device for storing, as CAD data, mask data corresponding to pattern layout data with respect to which a critical area is to be obtained; operating means for executing the first or second yield calculation method of this invention by using the mask data read from the storage device; and outputting means for outputting information of the yield obtained by the operating means.

In other words, the yield calculation apparatus of this invention is an apparatus for executing the first or second yield calculation method of this invention, and therefore, the effects described with respect to the yield calculation method can be attained.

In order to achieve the second object, the third yield calculation method of this invention for calculating a yield of vias on the basis of an evaluation result obtained by using a test chip having a via chain composed of a lower interconnect, an upper interconnect and the vias for connecting the lower interconnect and the upper interconnect to each other includes the step of calculating a yield of the vias alone by dividing a yield calculated on the via chain by yields of the lower interconnect and the upper interconnect.

In the third yield calculation method, the yield of vias alone can be separately obtained on the basis of the yield of a via chain widely used for via yield calculation. Therefore, a step affecting the yield of actual products can be accurately extracted, so that a method or the like for improving the yield can be rapidly selected by utilizing the extraction result.

The third yield calculation method may further include the steps of calculating critical areas of the vias by using layout data of the test chip; and calculating a density of defects causing random defect failures of the vias on the basis of the yield of the vias calculated in the step of calculating a yield and the critical areas of the vias calculated in the step of calculating critical areas.

In order to achieve the third object, the second pattern analysis method of this invention for an electronic device including a via, includes the step of calculating, as a critical area of the via, two or more kinds of open critical areas including at least a hard open critical area and a soft open critical area.

In the second pattern analysis method, two or more kinds of open critical areas including at least a hard open critical area and a soft open critical area are calculated as the critical area of the via. Therefore, the critical area with respect to a soft open failure of the via, namely, the yield, can be obtained separated from that with respect to a hard open failure of the via.

In the second pattern analysis method, the step of calculating two or more kinds of open critical areas may include a sub-step of defining a pattern region that has a center according to a center of the via and has a specific homothetic ratio to the via as a hard open critical area calculation via region and defining a region of the via excluding the hard open critical area calculation via region as a soft open critical area calculation via region. The specific homothetic ratio can be appropriately set in accordance with the process conditions for forming the via. Specifically, the specific homothetic ratio may be set within a range from 5:1 to 5:4, and for example, to 2:1.

Also, in the second pattern analysis method, the step of calculating two or more kinds of open critical areas may include a sub-step of determining that a hard open failure occurs when a defect that may cause a random defect failure and has a dimension with a value not smaller than a product of a dimension of the via and a given value is present in the hard open critical area calculation via region and determining that a soft open failure occurs when the defect is present in the soft open critical area calculation via region but is not present in the hard open critical area calculation via region. The size of a defect to be employed as a criterion of the pattern analysis may be set to be not smaller than a value ½ times as large as the dimension of the via when the homothetic ratio is set to 2:1 (½), or may be set to be smaller than a value ⅕ times as large as the dimension of the via when the homothetic ratio is set to 5:1 (⅕).

In the second pattern analysis method, when, for example, a hard open critical area and a soft open critical area are to be calculated, the first pattern analysis method of this invention can be employed. Specifically, a critical area is calculated by replacing a “via” with a “hard open critical area calculation via region” in the first pattern analysis method, and the thus obtained critical area is defined as a “hard open critical area”. Subsequently, a “soft open critical area” can be calculated by subtracting the “hard open critical area” from a critical area calculated on the basis of the data of the actual via in the first pattern analysis method.

As described so far, the present invention provides a method and an apparatus for obtaining a yield of vias in an electronic device such as a semiconductor device. The invention is very useful because it attains an effect to calculate the yield of vias in consideration of random defect failures, an effect to obtain the yield of vias separately from the yield of another constituting element, and an effect to obtain a critical area and a yield related to soft open failures of vias separately from those related to hard open failures.

### BRIEF DESCRIPTION OF THE DRAWINGS

FIGS. 1A, 1B and 1C are diagrams for explaining the relationship between the sizes of a via and a defect and a via connection failure in a pattern analysis method, a pattern analysis apparatus, a yield calculation method and a yield calculation apparatus according to Embodiment 1 of the invention;

FIG. 2 is a diagram for explaining a space region between vias used in the pattern analysis method, the pattern analysis apparatus, the yield calculation method and the yield calculation apparatus according to Embodiment 1 of the invention;

FIGS. 3A, 3B, 3C and 3D are diagrams for explaining a critical area used in the pattern analysis method, the pattern analysis apparatus, the yield calculation method and the yield calculation apparatus according to Embodiment 1 of the invention;

FIG. 4 is a diagram for showing an exemplified architecture of the pattern analysis apparatus of Embodiment 1 of the invention;

FIG. 5 is a flowchart for the pattern analysis method of Embodiment 1 of the invention;

FIG. 6A is a diagram of a part of a layout of a via pattern in which a critical area is obtained in the pattern analysis method of Embodiment 1 and FIG. 6B is a list for showing categories of space regions of vias obtained in the pattern analysis method of Embodiment 1 of the invention;

FIG. 7 is a diagram for showing an exemplified via pattern obtained by re-defining the via pattern in the pattern analysis method of Embodiment 1 of the invention;

FIG. 8A is a diagram for showing critical areas Ca₁(x) of vias having a space region of a first category obtained in the pattern analysis method of Embodiment 1 together with a defect particle size distribution D0(x) with the abscissa indicating a defect size x, and FIG. 8B is a diagram for showing critical areas Caₙ(x) of vias having a space region of an nth category obtained in the pattern analysis method of Embodiment 1 together with the defect particle size distribution D0(x) with the abscissa indicating the defect size x;

FIG. 9A is a diagram for showing an exemplified state where layout data of vias is divided into a hard open region and a soft open region in a pattern analysis method according to a modification of Embodiment 1, FIG. 9B is a diagram of a criterion of a hard open failure used in the pattern analysis method according to the modification of Embodiment 1 and FIG. 9C is a diagram of a criterion of a soft open failure used in the pattern analysis method according to the modification of Embodiment 1;

FIGS. 10A, 10B and 10C are diagrams for explaining a pattern analysis method according to Embodiment 2 of the invention;

FIG. 11A is a plan view of a test chip having a via chain used in a yield calculation method according to Embodiment 3 of the invention, FIG. 11B is a plan view of a test chip for evaluating upper interconnect open/short used in the yield calculation method according to Embodiment 3 of the invention and FIG 11C is a plan view of a test chip for evaluating lower interconnect open/short used in the yield calculation method according to Embodiment 3 of the invention; and

FIG. 12A is a diagram for showing an exemplified plan structure of a via chain and FIG. 12B is a diagram for showing a lower interconnect failure, an upper interconnect failure and a via failure caused in the via chain.

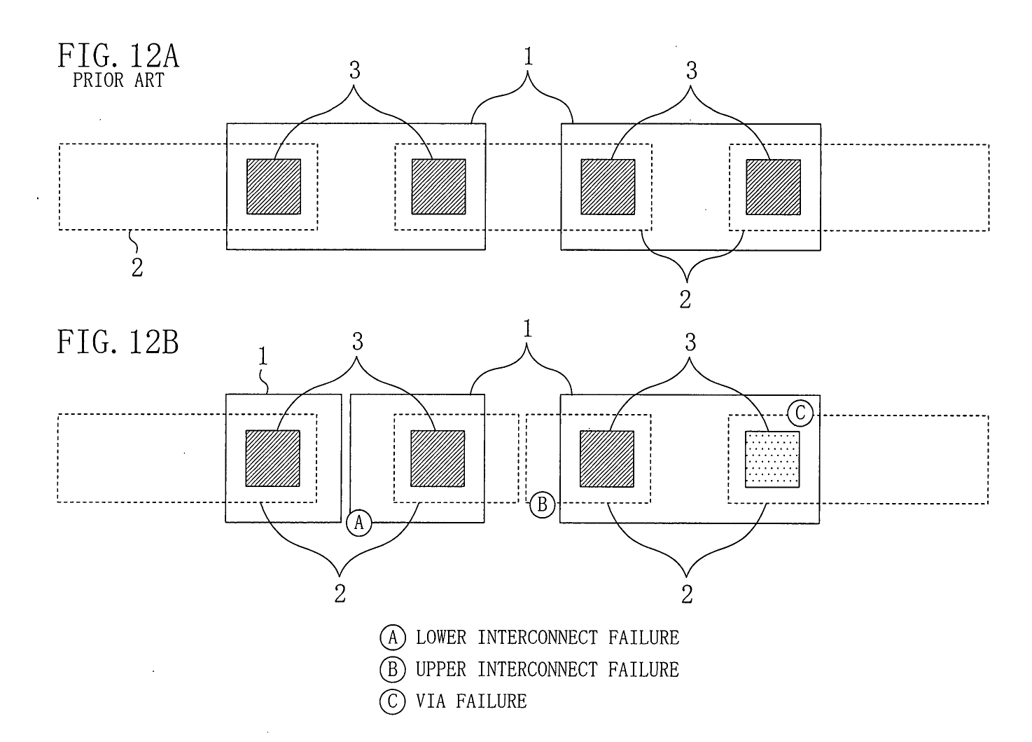

### DETAILED DESCRIPTION OF THE INVENTION

### Embodiment 1

A pattern analysis method, a pattern analysis apparatus, a yield calculation method and a yield calculation apparatus according to Embodiment 1 of the invention will now be described with reference to the accompanying drawings by exemplifying pattern analysis and yield calculation of an electronic device including a plurality of vias, such as a semiconductor device.

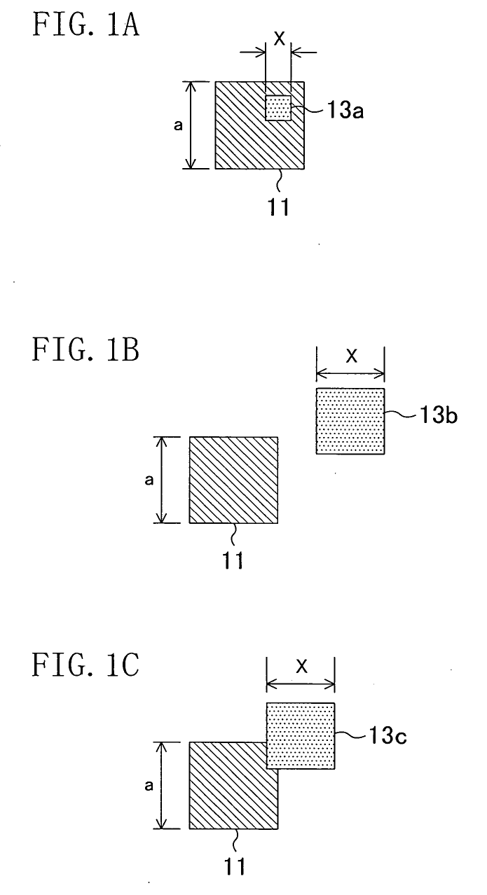

First, a “via critical area”, that is, the basic technical concept of this invention, will be described with reference to FIGS. 1A through 1C. In this embodiment, the relationship between the sizes of a via and a defect and a via connection failure is defined as follows:

Definition A: A via is in a shape of a square with each side having a length a.

Definition B: A defect is in a shape of a square with each side having a length x.

Definition C: In the case where the length x of each side of a defect 13a is smaller than a half of the length a of each side of a via 11 (=a/2) as shown in FIG. 1A, it is assumed that a contact failure (via connection failure) does not occur regardless of the overlap state between the via 11 and the defect 13a. In other words, either when the defect 13a is completely overlapped on the via 11 or when the defect 13a is partially overlapped on the via 11, it is assumed that a contact failure (via connection failure) does not occur. In the definition C, the minimum value of the length of each side of a defect possibly causing a contact failure (that is, a half of the length of each side of a via in this embodiment) depends upon process conditions and is set to a value not smaller than ⅕ and not larger than ⅘ of the length of each side of a via in accordance with the process conditions.

Definition D: In the case where the length x of each side of a defect 13b is not smaller than a half of the length a of each side of a via 11 (=a/2) and the defect 13b is not overlapped on the via 11 as shown in FIG. 1B, it is assumed that a contact failure (via connection failure) does not occur. Also in the definition D, the minimum value of the length of each side of a defect possibly causing a contact failure is not limited to the half of the length of each side of a via as in the definition C.

Definition E: In the case where the length x of each side of a defect 13c is not smaller than a half of the length a of each side of a via 11 (=a/2), when the defect 13c is even partially overlapped on the via 11, it is assumed that a contact failure (via connection failure) occurs as shown in FIG. 1C. Needless to say, when the defect 13c is completely overlapped on the via 11, a contact failure (via connection failure) occurs. Also in the definition E, the minimum value of the length of each side of a defect possibly causing a contact failure is not limited to the half of the length of each side of a via as in the definition C.

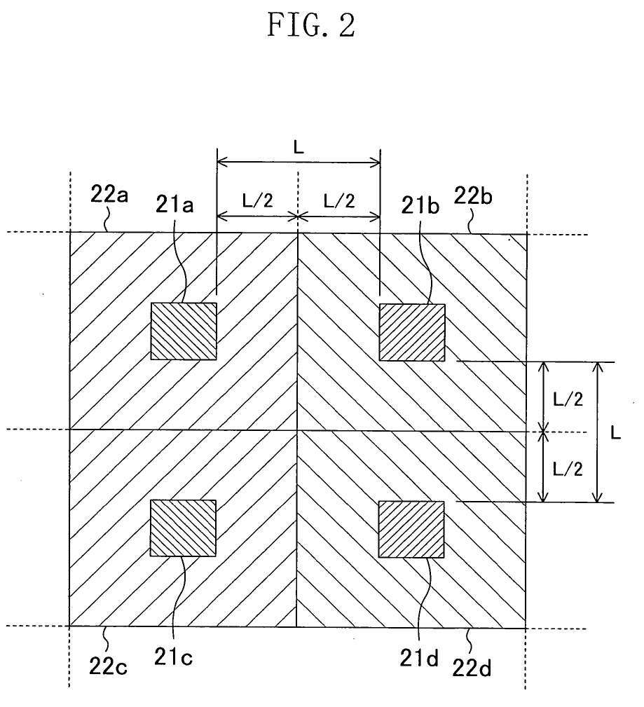

Subsequently, definition of a space region between vias used in this embodiment will be described with reference to FIG. 2.

In this embodiment, it is assumed that a plurality of vias 21 are arranged on a substrate at an equal distance L (which is a distance from the edge of one via to the edge of another adjacent via) in the form of an array as shown in FIG. 2. Although four vias 21a, 21b, 21c and 21d are shown in FIG. 2 for convenience sake, it is assumed that other vias are similarly present around the four vias. Herein, a region from the edge of the via 21a to a distance L/2 is defined as a space region 22a of the via 21a, and space regions 22b, 22c and 22d of the vias 21b, 21c and 21d are similarly defined.

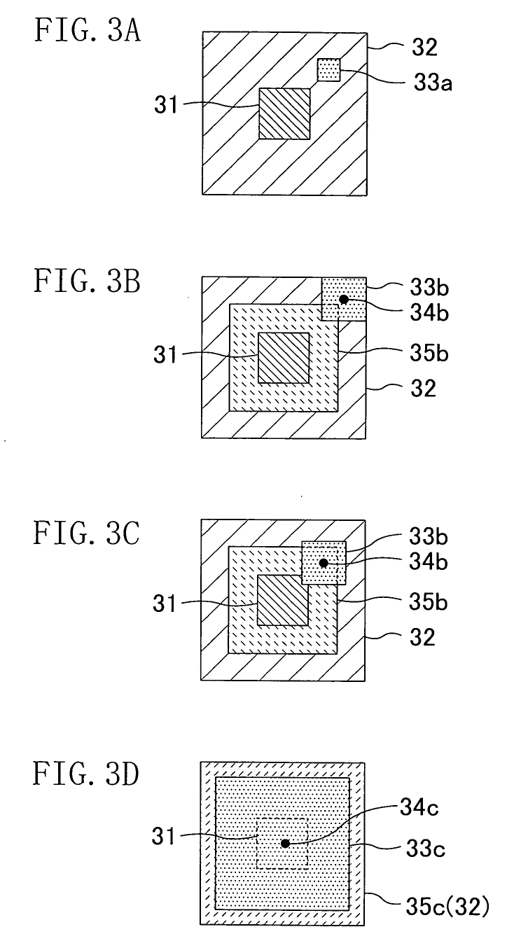

Next, the relationship between a critical area Ca(x), that is, a function of the size x of a defect, and the space region of a via and the size of a defect will be described with reference to FIGS. 3A through 3D. In FIGS. 3A through 3D, it is assumed that a plurality of vias with each side having a length a are arranged on a substrate at an equal distance L (which is a distance from the edge of one via to the edge of another adjacent via) in the form of an array, but merely one via 31 will be herein described for convenience sake. As shown in FIGS. 3A through 3D, the via 31 has a space region 32 defined with reference to FIG. 2. Specifically, the space region 32 is in a shape of a square with each side having a length (a+L) and the center of the space region 32 accords with the center of the via 31.

In the case where the length x of each side of a defect 33a is smaller than a/2 as shown in FIG. 3A, a via connection failure does not occur no matter where the center of the defect 33a is present in the space region 32. In other words, the critical area Ca(x) of the via 31 is 0 (zero) in this case.

Alternatively, in the case where the length x of each side of a defect 33b is not smaller than a/2 and smaller than L and the defect 33b is not overlapped on the via 31 as shown in FIG. 3B, a via connection failure does not occur. On the other hand, in the case where the length x of each side of the defect 33b is not smaller than a/2 and smaller than L and the defect 33b is overlapped on the via 31 even slightly as shown in FIG. 3C, a via connection failure occurs. In other words, a critical area 35b, which is obtained in the case where the length x of each side of the defect 33b is not smaller than a/2 and smaller than L, is in a shape of a square with each side having a length (a+x) as shown in FIGS. 3B and 3C. Therefore, the critical area Ca(x) of the via 31 is (a+x)². It is noted that FIG. 3B shows a case where the center 34b of the defect 33b is not overlapped on the critical area 35b and that FIG. 3C shows a case where the center 34b of the defect 33b is overlapped on the critical area 35b.

Alternatively, in the case where the length x of each side of a defect 33c is not smaller than L as shown in FIG. 3D, a via connection failure always occurs because the defect 33c is overlapped on the via 31 no matter where the center 34c of the defect 33c is present in the space region 32. In other words, a critical area 35c, which is obtained in the case where the length x of each side of the defect 33c is not smaller than L, is in a shape of a square with each side having a length (a+L) as shown in FIG. 3D. Therefore, the critical area Ca(x) of the via 31 is (a+L)². It is noted that FIG. 3D shows a case where the center 34c of the defect 33c is overlapped on the center of the via 31. Also, even when the defect 33c is larger than the space region 32, the critical area Ca(x) remains to be (a+L)². This is because a portion of the defect 33c outside the space region 32 of the via 31 is considered as a critical area of another via adjacent to the via 31.

Although it is assumed in the above description that a plurality of vias are arranged on a substrate at an equal distance L in the form of an array as shown in FIG. 2, vias are not always arranged as shown in FIG. 2 in an actual semiconductor device or the like. In other words, distances between vias may be various instead of being equal and the vias may be arranged in a non-array manner. Now, a method and an apparatus for calculating a critical area of a via in such an actual semiconductor device or the like and a method and an apparatus for calculating a yield of vias in consideration of random defect failures on the basis of the critical area will be described in detail.

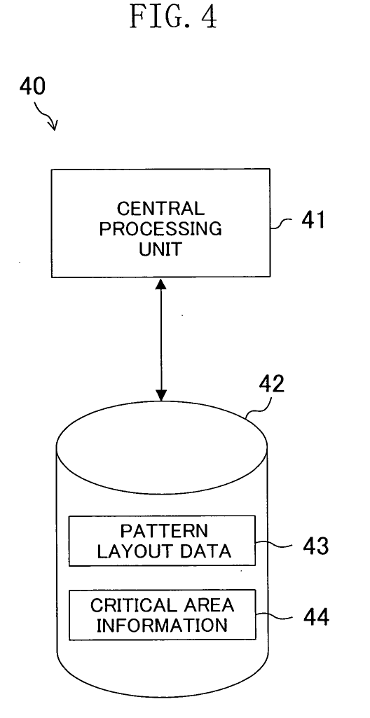

FIG. 4 is a diagram for showing an example of the architecture of the pattern analysis apparatus according to this embodiment. As shown in FIG. 4, the pattern analysis apparatus 40 of this embodiment includes a central processing unit (CPU) 41 and a storage device 42 for storing pattern layout data 43 including a via pattern and critical area information 44. As operating means, the CPU 41 reads the pattern layout data 43 from the storage device 42 and executes the pattern analysis method of this embodiment described below by using the read pattern layout data 43. Also, as outputting means, the CPU 41 outputs, to the storage device 42, the critical area information 44 obtained as a result of the execution of the pattern analysis method of this embodiment.

It goes without saying that the architecture of the pattern analysis apparatus used for practicing the pattern analysis method of this embodiment described below is not limited to that shown in FIG. 4.

Also, an exemplified architecture of the yield calculation apparatus of this embodiment is different from that of the pattern analysis apparatus shown in FIG. 4 as follows: As operating means, the CPU 41 not only executes the pattern analysis method but also reads the critical area information 44 from the storage device 42 and executes the yield calculation method of this embodiment described below by using the read critical area information 44. Also, as outputting means, the CPU 41 outputs, to the storage device 42, yield information obtained as a result of the execution of the yield calculation method of this embodiment. Further more, the storage device 42 stores not only the pattern layout data 43 and the critical area information 44 but also the yield information.

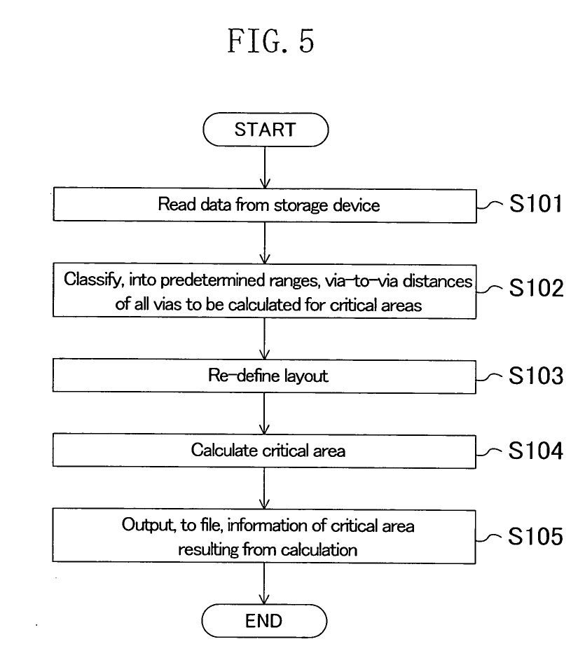

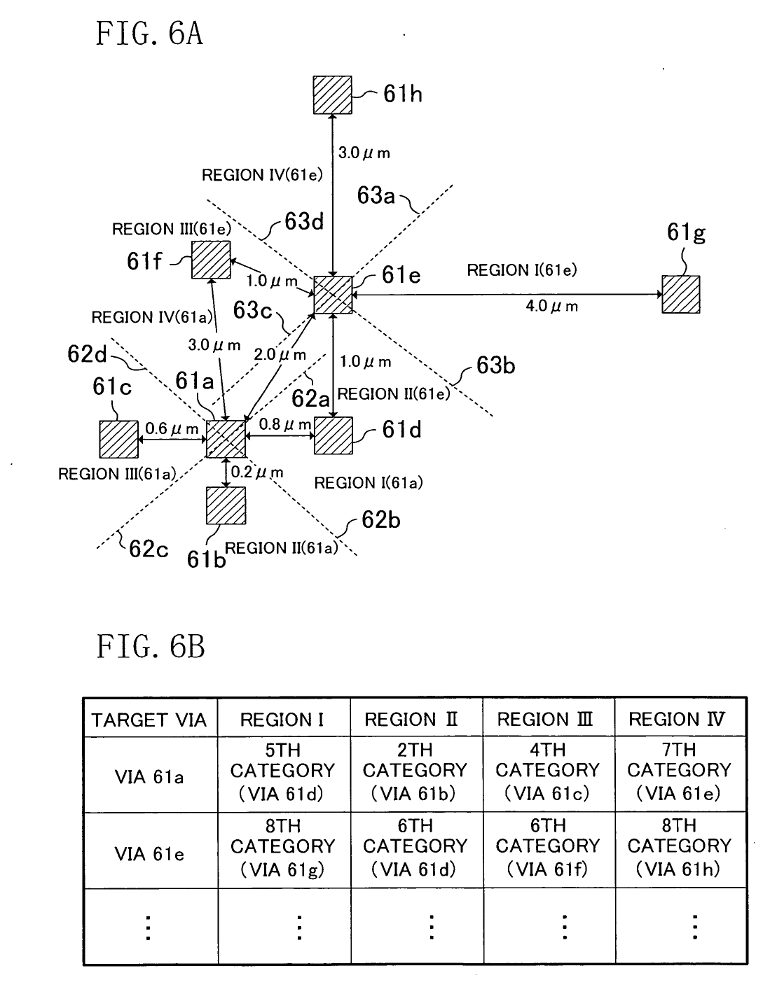

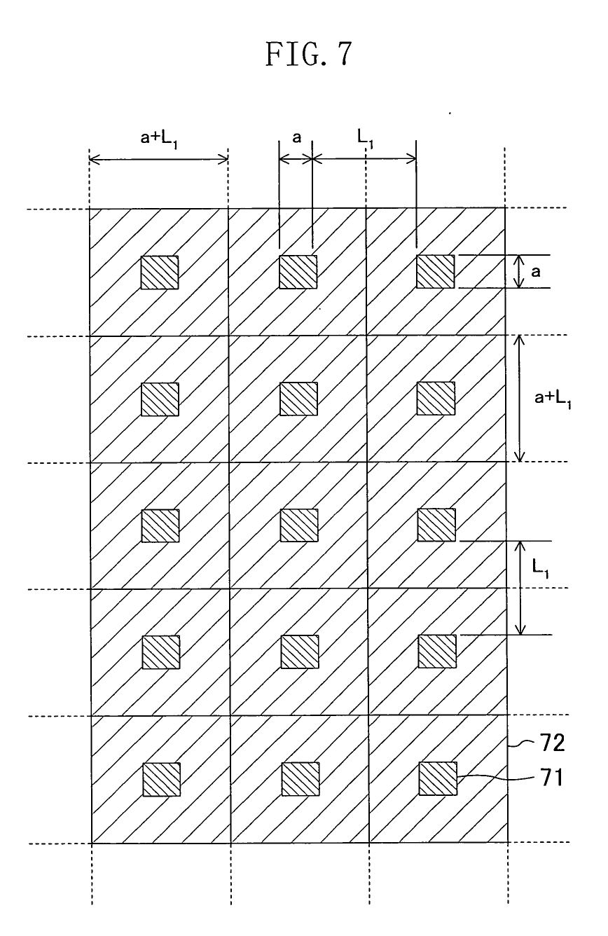

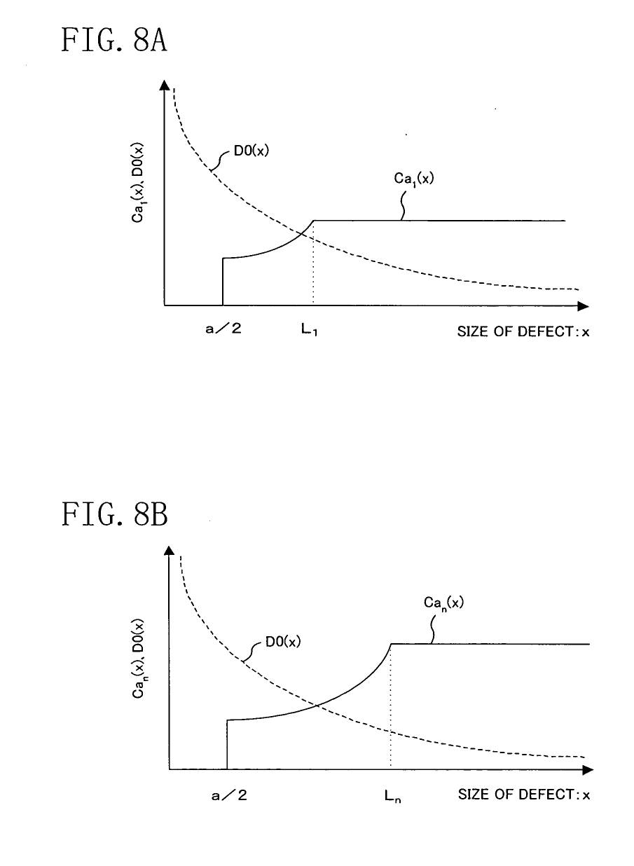

FIG. 5 is a flowchart for the pattern analysis method of this embodiment using the pattern analysis apparatus of FIG. 4. Also, FIGS. 6A, 6B and 7 are diagrams for explaining respective steps of the flowchart of FIG. 5, and FIG. 8 is a diagram for explaining the yield calculation method using the critical area obtained by the pattern analysis method of this embodiment.

First, in a first step S101, the pattern layout data 43, which is specifically mask data used as layout data of a specific via pattern where a critical area is to be obtained, is read as CAD (computer aided design) data from the storage device 42 corresponding to a memory region of a computer.

FIG. 6A shows a part of the layout of the via pattern where a critical area is to be obtained in this embodiment. As shown in FIG. 6A, a plurality of vias 61a, 61b, 61c, 61d, 61e, 61f, 61g and 61h are disposed. In this case, a distance between the vias 61a and 61b is 0.2 μm, a distance between the vias 61a and 61c is 0.6 μm, a distance between the vias 61a and 61d is 0.8 μm, a distance between the vias 61a and 61e is 2.0 μm, a distance between the vias 61a and 61f is 3.0 μm, a distance between the vias 61e and 61f is 1.0 μm, a distance between the vias 61e and 61g is 4.0 μm, a distance between the vias 61e and 61d is 1.0 μm, and a distance between the vias 61e and 61h is 3.0 μm. It is noted that other plurality of vias are assumed to be present outside the range shown in FIG. 6A in the layout of the via pattern to be dealt with in this embodiment.

Next, in a second step S102, with respect to all the vias whose critical areas are to be calculated, distances between the vias (via-to-via distances) are classified into predetermined ranges. Specifically, the distances are classified as follows: For example, a via-to-via distance of 0.1 μm or less is classified as a first category, a via-to-via distance larger than 0.1 μm and not larger than 0.2 μm is classified as a second category, a via-to-via distance larger than 0.2 μm and not larger than 0.4 μm is classified as a third category, a via-to-via distance larger than 0.4 μm and not larger than 0.6 μm is classified as a fourth category, a via-to-via distance larger than 0.6 μm and not larger than 0.8 μm is classified as a fifth category, a via-to-via distance larger than 0.8 μm and not larger than 1.0 μm is classified as a sixth category, a via-to-via distance larger than 1.0 μm and not larger than 2.0 μm is classified as a seventh category, a via-to-via distance larger than 2.0 μm and not larger than 5.0 μm is classified as an eighth category, a via-to-via distance larger than 5.0 μm and not larger than 10.0 μm is classified as a ninth category, and a via-to-via distance larger than 10.0 μm is classified as a tenth category. In the case where any via whose critical area is to be calculated has a plurality of via-to-via distances in any of the aforementioned ranges, the minimum via-to-via distance out of the plural via-to-via distances is defined as a dimension of the space region of the via.

Specifically, as shown in FIG. 6A, in each of four regions partitioned by four half-lines starting from a specific via (a target via) selected from the plural vias 61, the minimum distance out of distances from the target vias to other adjacent vias is defined as a dimension of the space region of a quarter of the target via corresponding to each of the four regions. In other words, in each of the four regions, a region from the target via to a distance corresponding to a half of the calculated distance is defined as the space region of a quarter of the target via corresponding to each of the four regions. In this case, for example, four border lines perpendicular to one another obtained by extending the diagonal lines of the target via (in the shape of a square in this embodiment) are used as the four half-lines and regions partitioned by the border lines are defined as the four regions as shown in FIG. 6A.

Specifically, in the case where the via 61a is the target via, a region surrounded with border lines 62a and 62b is defined as a region I(61a) of the via 61a, a region surrounded with border lines 62b and 62c is defined as a region II(61a) of the via 61a, a region surrounded with border lines 62c and 62d is defined as a region III(61a) of the via 61a, and a region surrounded with the border lines 62d and 62a is defined as a region IV(61a) of the via 61a. In the region I(61a), a via spaced from the via 61a by the minimum distance is the via 61d and a distance between the vias 61a and 61d is 0.8 μm. Also, in the region II(61a), a via spaced from the via 61a by the minimum distance is the via 61b and a distance between the vias 61a and 61b is 0.2 μm. In the region III(61a), a via spaced from the via 61a by the minimum distance is the via 61c and a distance between the vias 61a and 61c is 0.6 μm. In the region IV(61a), the vias 61e and 61f are adjacent to the via 61a, and a via spaced from the via 61a by the minimum distance is the via 61e and a distance between the vias 61a and 61e is 2.0 μm.

Accordingly, in the region I(61a), the distance between the vias 61a and 61d, that is, 0.8 μm, is classified as the fifth category, and therefore, a quarter of the via 61a corresponding to the region I(61a) has a space region of the fifth category. Also, in the region II(61a), the distance between the vias 61a and 61b, that is, 0.2 μm, is classified as the second category, and therefore, a quarter of the via 61a corresponding to the region II(61a) has a space region of the second category. In the region III(61a), the distance between the vias 61a and 61c, that is, 0.6 μm, is classified as the fourth category, and therefore, a quarter of the via 61a corresponding to the region 111(61a) has a space region of the fourth category. In the region IV(61a), the distance between the vias 61a and 61e, that is, 2.0 μm, is classified as the seventh category, and therefore, a quarter of the via 61a corresponding to the region IV(61a) has a space region of the seventh category.

Similarly, when the via 61e is the target via, similar processing as that for the via 61a is performed with respect to four regions partitioned by border lines 63a, 63b, 63c and 63d, namely, regions I(61e), II(61e), III(61e) and IV(61e). FIG. 6B is a list for showing the categories of the space regions of the vias 61a and 61e thus obtained and vias adjacent to the vias 61a and 61e.

Next, in the case where the vias 61a and 61e are together considered, a via having a space region of the second category is the quarter corresponding to the region 11(61a) of the via 61a alone, and hence, the total number of vias having the space region of the second category is 1/4. Also, a via having a space region of the fourth category is the quarter corresponding to the region III(61a) of the via 61a alone, and hence, the total number of vias having the space region of the fourth category is also 1/4. Also, a via having a space region of the fifth category is the quarter corresponding to the region I(61a) of the via 61a alone, and hence, the total number of vias having the space region of the fifth category is also 1/4. Furthermore, vias having a space region of the sixth category are the quarter corresponding to the region II(61e) of the via 61e and the quarter corresponding to the region III(61e) of the via 61e, and hence, the total number of vias having the space region of the sixth category is ½. Also, a via having a space region of the seventh category is the quarter corresponding to the region IV(61a) of the via 61a alone, and hence, the total number of vias having the space region of the seventh category is also 1/4. Furthermore, vias having a space region of the eighth category are the quarter corresponding to the region I(61e) of the via 61e and the quarter corresponding to the region IV(61e) of the via 61e, and hence, the total number of vias having the space region of the eighth category is ½.

Although the calculation of the total numbers of vias having the space regions of the respective categories is herein described with respect to the vias 61a and 61e alone for simplification, when the aforementioned processing is performed on all the vias included in the via pattern in which a critical area is to be obtained, the number of vias having a space region of an nth category (wherein n is an integer of 1 through 10) can be obtained.

Next, in a third step S103, the layout of the via pattern is re-defined. Specifically, it is assumed that the vias having the space region of the nth category in the number calculated in the second step S102 are arranged on the substrate at an equal distance Lₙ (wherein n corresponds to the nth category) in the form of an array. Herein, a distance L₁ is 0.1 μm, a distance L₂ is (0.1 μm+0.2 μm)/2, a distance L₃ is (0.2 μm+0.4 μm)/2, a distance L₄ is (0.4 μm+0.6 μm)/2, a distance L₅ is (0.6 μm+0.8 μm)/2, a distance L₆ is (0.8 μm+1.0 μm)/2, a distance L₇ is (1.0 μm+2.0 μm)/2, a distance L₈ is (2.0 μm+5.0 μm)/2, a distance L₉ is (5.0 μm+10.0 μm)/2 and a distance L₁₀ is 10.0 μm.

FIG. 7 shows an example of the re-defined via pattern. As shown in FIG. 7, for example, a plurality of vias 71 having a space region 72 of the first category are arranged on the substrate at an equal distance L₁ in the form of an array. In other words, the distance between the vias 71 is L₁. Also, the space region 72 is in the shape of a square with each side having a length a+L₁, the via 71 is in the shape of a square with each side having a length a, and the center of the space region 72 and the center of the via 71 accord with each other. With respect to vias having the space regions of the second through tenth categories, the layouts are similarly re-defined.

Next, in a fourth step S104, the critical area calculation described with reference to FIG. 3 is performed respectively on the vias having the space regions of the first through tenth categories.

Specifically, a critical area Ca₁₁(x) of each via having the space region of the first category is expressed as the following formulas 6-1, 6-2 and 6-3, wherein a is the length of each side of the via and x is the size of a defect:
Ca₁₁(x)=0 (0≦x<a/2) Formula 6-1:
Ca₁₁(x)=(a+x)² (a/2≦x<L₁) Formula 6-2:
Ca₁₁(x)=(a+L₁)² (L₁≦x) Formula 6-3:

Similarly, a critical area Caₙ₁(x) of each via having the space region of the nth category is expressed as the following formulas 7-1, 7-2 and 7-3:
Caₙ₁(x)=0 (0≦x<a/2) Formula 7-1:
Caₙ₁(x)=(a+x)² (a/2≦x<Lₙ) Formula 7-2:
Caₙ₁(x)=(a+Lₙ)² (Lₙ≦x) Formula 7-3:

Also, assuming that the number of vias having the space region of the first category is N₁, a total critical area Ca₁(x) of the N₁, vias is expressed as the following Formula 8-1:
Ca₁(x)=N₁·Ca₁₁(x) Formula 8-1:

Similarly, assuming that the number of vias having the space region of the nth category is Nₙ, a total critical area Caₙ(x) of the Nₙ, vias is expressed as the following Formula 8-2:
Caₙ(x)=Nₙ·Caₙ₁(x) Formula 8-2:

Then, in a fifth step S105, information of the critical areas calculated in the fourth step S104 (corresponding to the critical area information 44 of FIG. 4) is output to a file on the storage device 42, and thus, the pattern analysis processing of this embodiment is completed.

Next, in the yield calculation method of this embodiment, the yield of the vias in consideration of random defect failures can be calculated in accordance with the Formula 4 (described in Summary of the Invention) on the basis of the critical area information 44 calculated in the fourth step S104, namely, the critical area information 44 stored in the storage device 42, and the density and distribution of defects (causing random defect failures) previously obtained. Now, this will be specifically described.

FIG. 8A is a diagram in which the critical area Ca₁(x) of the vias having the space region of the first category is schematically shown with a solid line with the defect size x indicated by the abscissa (see Formulas 6-1 through 6-3). Similarly, FIG. 8B is a diagram in which the critical area Caₙ(x) of the vias having the space region of the nth category is schematically shown with a solid line with the defect size x indicated by the abscissa (see Formulas 6-1 through 6-3). In each of FIGS. 8A and 8B, the defect particle size distribution D0(x) of the defect density separately obtained is schematically shown with a broken line with the defect size x indicated by the abscissa.

At this point, a yield Y₁ of the vias having the space region of the first category and a yield Yₙ of the vias having the space region of the nth category can be expressed, on the basis of the critical areas Ca₁(x) and Caₙ(x) of the vias and the defect particle size distribution D0(x) of the defect density by using the Formulas 4 and 4′ (described in Summary of the Invention), as the following Formulas 9-1 and 9-2:
Y₁=exp(−∫Ca₁(x)·D0(x)dx) Formula 9-1:
Yₙ=exp(−∫Caₙ(x)·D0(x)dx) Formula 9-2:

Accordingly, the yield Y of all the vias in consideration of random defect failures can be obtained in accordance with the following Formula 10, namely, as a product of the respective yields of the vias having the space regions of the first through nth categories:
Y=Y₁×Y₂× . . . ×Yₙ₋₁×Yₙ Formula 10:

In this manner, according to this embodiment, a critical area of an arbitrary via out of a plurality of vias is obtained by using the sizes of the plural vias included in an electronic device, the sizes of defects causing random defect failures and via-to-via distances of the arbitrary via out of the plural vias. Therefore, the fraction defective of the vias with respect to the random defect can be simply and accurately calculated by using the obtained critical areas. In other words, the fraction defective of the vias with respect to the random defect failures, namely, the yield, can be simply and accurately calculated on the basis of the thus obtained critical areas and the density and distribution of defects (causing random defect failures of the vias) previously obtained. Accordingly, even in a complicated pattern of an LSI with a high degree of integration, a highly precise yield, namely, a yield very close to the yield of actual products, can be rapidly calculated.

In this embodiment, after the layouts of the vias having the space regions of the first through tenth categories are re-defined in the third step S103, the critical areas of the vias having the space regions of the first through tenth categories are calculated in the fourth step S104. Instead, the layout re-definition and the critical area calculation may be successively performed on the vias having the space region of each category.

Also, although the relationship between the sizes of the vias and the defects and the via connection failure is defined as in the definitions A through E in this embodiment, the definition of the relationship is not particularly specified but may be appropriately optimized in accordance with, for example, the states of the process, the fabrication apparatus and the like. For example, the via shape is defined to be a square in the definition A, but it may be defined to be another polygonal or circular shape instead. Also, the defect shape is defined to be a square in the definition B, but it may be defined to be another polygonal or circular shape instead. Furthermore, the shape of the via or the defect may be defined to have a gentle curve on the apex of a polygon. Also, instead of the definitions C through E, another definition such as a definition that a via connection failure occurs merely when the size of a defect is larger than the size of a via may be employed. Furthermore, instead of the definition E, another definition such as a definition that a via connection failure occurs when a half or more of the area of a via is covered with a defect. When the definitions of the failure occurrence conditions are thus modified, it is necessary to change the definition of the shape of a space region (such as that shown in FIG. 2) and the calculation formulas for a critical area (such as Formulas 6-1 through 6-3 and 7-1 through 7-3) in accordance with the modification of the definitions.

Moreover, the method for classifying the via-to-via distances employed in the second step S102 is not limited to that described above, and the number of categories of the via-to-via distances is not limited to ten.

Furthermore, in this embodiment, in each of the four regions partitioned by the four half-lines starting from a target via, the minimum distance out of the distances from the target via to other adjacent vias is defined as the dimension of the space region of the quarter of the target via in the second step S102, which does not limit the invention. Instead, in each of n (wherein n is an integer of two or more) regions partitioned by n half-lines starting from a target via, the minimum distance out of the distances from the target via to other adjacent vias may be defined as the dimension of the space region of 1/n of the target via. In this case, the sizes of the respective regions are preferably equal or substantially equal to one another. Alternatively, a distance from the target via to another adjacent via may be calculated, so as to define a region from the target via to a half of the calculated distance as the space region of the target via.

Moreover, the pattern analysis method of this embodiment preferably further includes, for example, between the first step S101 and the second step S102, a step of excluding, from a target region where the critical areas are to be calculated, a region in which a dummy pattern (i.e., a pattern not functioning in actual use of the product, such as a dummy interconnect pattern used for improving the lithography accuracy) of the layout data of the via pattern is disposed. Thus, the critical areas can be accurately calculated with the dummy pattern not related to the yield of the actual product excluded, and therefore, a more highly precise yield closer to the yield of actual products can be calculated by using the critical areas.

### Modification of Embodiment 1

A pattern analysis method, a pattern analysis apparatus, a yield calculation method and a yield calculation apparatus according to a modification of Embodiment 1 of the invention will now be described with reference to the accompanying drawings by exemplifying pattern analysis and yield calculation of an electronic device including a plurality of vias, such as a semiconductor device.

Also in this modification, failures of vias (via connection failures) are divided into open failures and short failures, and a yield of vias derived from the open failures is calculated as in Embodiment 1. However, in this modification, the open failures of vias are further divided into soft open failures and hard open failures differently from Embodiment 1. In this case, it is necessary to divide evaluation results of a test chip into short, soft open and hard open for calculating the yield. Also, in the case where a critical area is to be calculated on the basis of layout data of a test chip, it is necessary to obtain a short critical area, a soft open critical area and a hard open critical area with respect to each of an upper interconnect, a lower interconnect and vias.

Specifically, in the calculation of a soft open critical area and a hard open critical area, the layout is divided into a region where hard open of a via is caused when a defect with a given or larger dimension is present (namely, a hard open region) and a region where soft open of a via is caused when such a defect is present (namely, a soft open region).

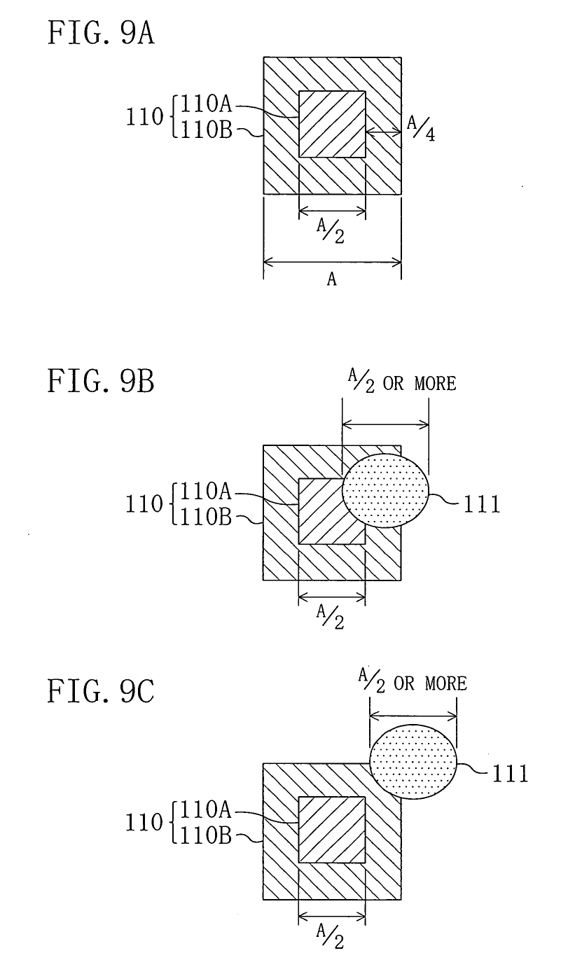

FIG. 9A shows an example of division of the via layout data into the hard open region and the soft open region.

As shown in FIG. 9A, a via 110 is divided into a hard open critical area calculation via region 110A whose center accords with the center of the via 110 and which is similar to the via 110 in a homothetic ratio of 2:1 and a soft open critical area calculation via region 110B which corresponds to a region of the via 110 excluding the hard open critical area calculation via region 110A. In other words, assuming that the via 110 has a dimension A, the hard open critical area calculation via region 110A has a dimension A/2, and the soft open critical area calculation via region 110B has a width A/4.

At this point, assuming that the size of a defect causing a failure is ½ or more of the via dimension A, when a defect 111 with a size not smaller than ½ of the via dimension A is even slightly overlapped on the hard open critical area calculation via region 110A as shown in FIG. 9B, it is determined that a hard open failure occurs. Also, when a defect 111 with a size not smaller than ½ of the via dimension A is overlapped on merely the soft open critical area calculation via region 110B as shown in FIG. 9C, it is determined that a soft open failure occurs.

On this assumption, a critical area is calculated by the method of Embodiment 1. Specifically, a critical area is calculated by replacing a “via” (such as the via 31 of FIG. 3C) with a “hard open critical area calculation via region” (such as the hard open critical area calculation via region 110A of FIG. 9A) in the method of Embodiment 1, and the thus obtained critical area is defined as a “hard open critical area”. Subsequently, a “soft open critical area” can be calculated by subtracting the “hard open critical area” from a critical area calculated on the basis of the data of the actual via in the method of Embodiment 1.

In this modification, since a hard open critical area and a soft open critical area are calculated as the critical area of a via, the critical area related to a soft open failure of vias, namely, the yield, can be obtained distinguishably from that related to a hard open failure of the via.

A method for calculating the yield of vias in consideration of random defect failures on the basis of respective critical areas obtained in the pattern analysis method of this modification is the same as that described in Embodiment 1. Also, the pattern analysis method and the yield calculation method of this modification can be practiced by using a pattern analysis apparatus (see FIG. 4) and a yield calculation apparatus similar to those of Embodiment 1.

In this modification, open failures of vias are divided into soft open failures of one condition and hard open failures of one condition, namely, open failures of two kinds of conditions in total. Instead, for example, soft open failures may be divided into soft open failures causing operation failures and soft open failures causing reliability failures, namely, soft open failures of two kinds of conditions, or soft open failures of three or more kinds of conditions. In other words, in this modification, two kinds or more open critical areas at least including the hard open critical area and the soft open critical area may be calculated.

Furthermore, the homothetic ratio of the hard open critical area calculation via region to the via is not particularly specified in this modification but may be appropriately determined in accordance with process conditions for forming the vias. Specifically, the homothetic ratio may be set within a range of 5:1 to 5:4 (which is 2:1 in this modification). Also, the size of a defect causing a failure is not particularly specified. For example, when the homothetic ratio is set to 2:1 (½), the size of a defect causing a failure may be set to be not less than ½ of the via dimension, or when the homothetic ratio is set to 5:1 (⅕), the size of a defect causing a failure may be set to be not less than ⅕ of the via dimension.

### Embodiment 2

A pattern analysis method and a pattern analysis apparatus according to Embodiment 2 of the invention will now be described with reference to the accompanying drawings by exemplifying pattern analysis of an electronic device including a plurality of vias, such as a semiconductor device.

Differently from Embodiment 1, as a characteristic of this embodiment, a hard open critical area and a soft open critical area described in the modification of Embodiment 1 are calculated by using the geometry method (see, for example, Non-patent document 6) or the Monte Carlo method (see, for example, Non-patent document 7) conventionally widely used.

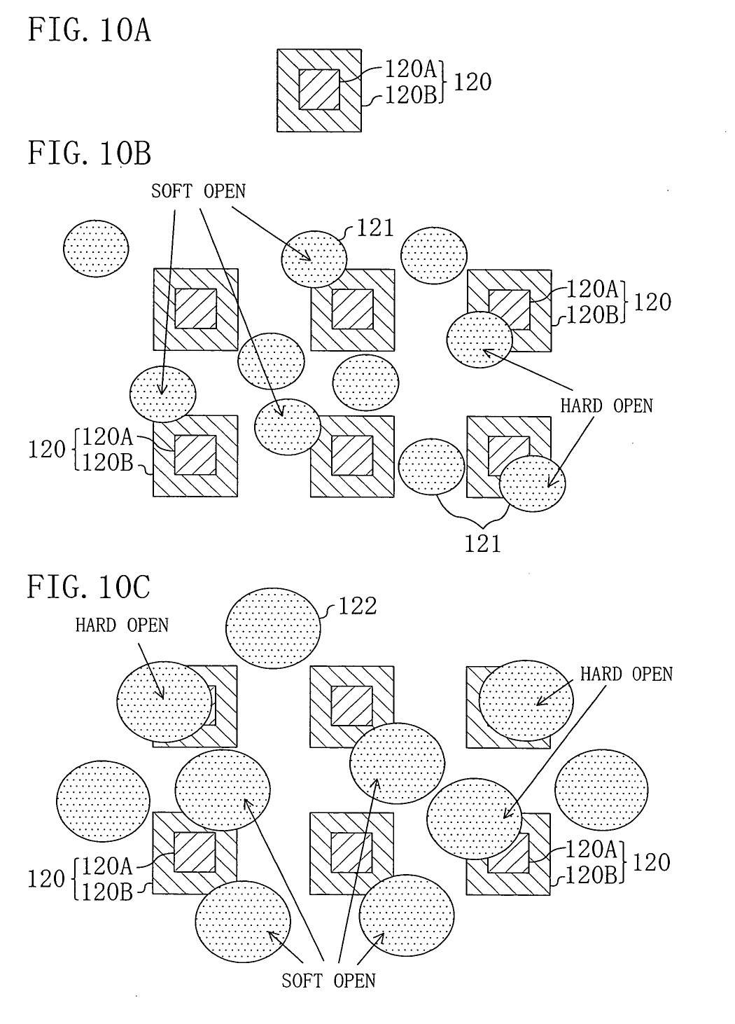

FIGS. 10A through 10C are diagrams for explaining a critical area calculation method of this embodiment performed by using, for example, the Monte Carlo method.

First, in the same manner as in the modification of Embodiment 1, each via 120 is divided into a hard open critical area calculation via region 120A whose center accords with the center of the via 120 and which is similar to the via 120 in a homothetic ratio of 2:1 and a soft open critical area calculation via region 120B which corresponds to a region of the via 120 excluding the hard open critical area calculation via region 120A as shown in FIG. 10A.

Next, the Monte Carlo method is employed for calculating a critical area on the basis of a ratio, obtained when defects with sizes larger than the size causing a failure are dispersed on an electronic device having a plurality of vias such as a semiconductor device, of the number of defects actually causing failures to the total number of dispersed defects. In actual calculation, for example, approximately 10000 defects are dispersed per 1 mm². Also, as the sizes of the dispersed defects, several tens kinds of sizes exceeding the size causing a failure are employed.

FIG. 10B shows a state where defects 121 each having a size corresponding to approximately ⅗ of the dimension of the via 120 are dispersed, wherein hard open failures are caused in a ratio of 2/10 and soft open failures are caused in a ratio of 3/10.

FIG. 10C shows a state where defects 122 each having a size equivalent to the dimension of the via 120 are dispersed, wherein hard open failures are caused in a ratio of 3/10 and soft open failures are caused in a ratio of 4/10.

It is noted that, in FIGS. 10B and 10C, the criteria of a hard open failure and a soft open failure are the same as those employed in the modification of Embodiment 1.

As described so far, according to Embodiment 2, a hard open critical area and a soft open critical area are calculated as the critical area of a via, and therefore, the critical areas related to soft open failures of vias, namely, the yield, can be obtained distinguishably from those related to hard open failures of the vias.

The pattern analysis method of this embodiment can be practiced by using a pattern analysis apparatus (see FIG. 4) similar to that of Embodiment 1. Specifically, the apparatus for practicing the pattern analysis method of this embodiment includes, for example, a storage device for storing various data necessary for practicing the method and a CPU for executing the method and outputting a result obtained by the execution.

Also, in this embodiment, open failures of vias are divided into soft open failures of one condition and hard open failures of one condition, namely, open failures of two kinds of conditions in total. Instead, for example, soft open failures may be divided into soft open failures causing operation failures and soft open failures causing reliability failures, namely, soft open failures of two kinds of conditions, or soft open failures of three or more kinds of conditions. In other words, in this embodiment, two or more kinds of open critical areas including at least a hard open critical area and a soft open critical area can be calculated.

Furthermore, the homothetic ratio of the hard open critical area calculation via region to the via is not particularly specified in this embodiment but may be appropriately determined in accordance with process conditions for forming the vias. Specifically, the homothetic ratio may be set within a range of 5:1 to 5:4 (which is 2:1 in this embodiment). Also, the size of a defect causing a failure is not particularly specified. For example, when the homothetic ratio is set to 2:1 (½), the size of a defect causing a failure may be set to be not less than ½ of the via dimension, or when the homothetic ratio is set to 5:1 (⅕), the size of a defect causing a failure may be set to be not less than ⅕ of the via dimension.

### Embodiment 3

A yield calculation method and a yield calculation apparatus according to Embodiment 3 of the invention will now be described with reference to the accompanying drawings by exemplifying yield calculation of an electronic device including a plurality of vias such as a semiconductor device.

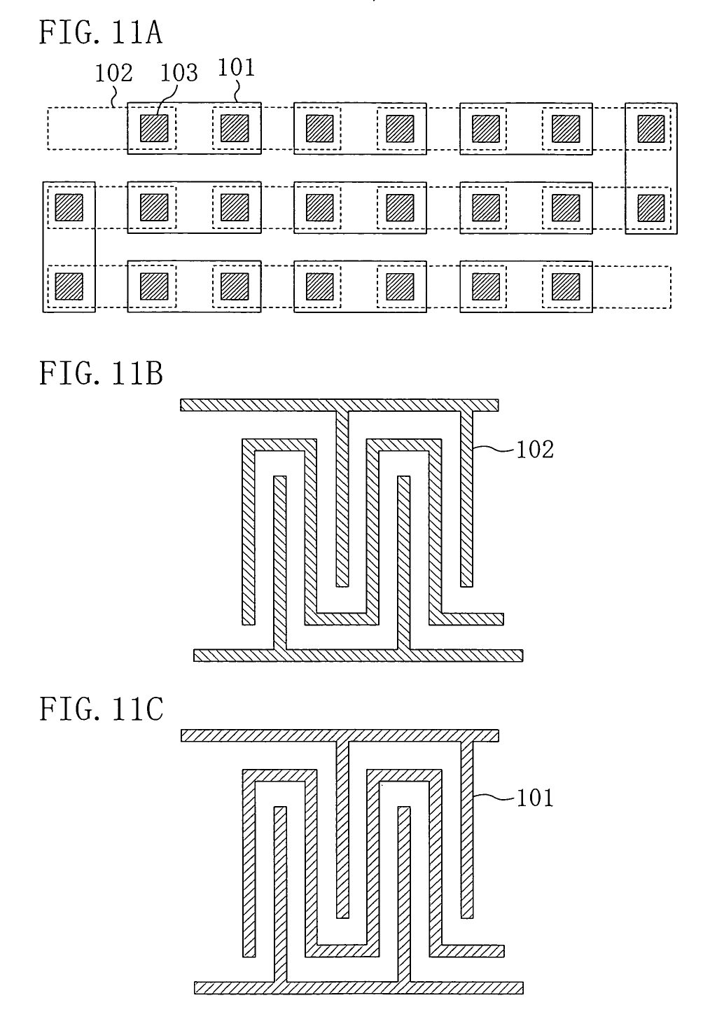

FIG. 11A shows the plan structure of a test chip used in this embodiment. As shown in FIG. 11A, a via chain composed of a lower interconnect 101, an upper interconnect 102 and vias 103 connecting them to each other is provided on the test chip.

Now, a method for obtaining the yield of vias by actually using the test chip of FIG. 11A and a method for obtaining a defect density of the vias on the basis of the obtained yield will be described in detail.

First, critical areas Ecalower, Ecaupper and Ecavia of the upper interconnect, the lower interconnect and the via are obtained by using the layout of the via chain. At this point, graphic data processing by a conventional method such as the Monte Carlo method or a line width increasing method (see, for example, Non-patent document 5 with respect to the critical area calculation of a via) may be employed.

Next, a test chip or the like for upper interconnect open/short evaluation, such as a test chip in a snake and comb shape shown in FIG 11B, is used to obtain a defect density D0upper of the upper interconnect. Thus, on the basis of the defect density D0upper of the upper interconnect and the critical area Ecaupper of the upper interconnect, a yield Yupper of the upper interconnect can be calculated in accordance with a relationship formula, Yupper=exp(−(D0upper×Ecaupper)), obtained from the aforementioned Formula 5-1.

Next, a test chip or the like for lower interconnect open/short evaluation, such as a test chip in a snake and comb shape shown in FIG. 11C, is used to obtain a defect density D0lower of the lower interconnect. Thus, on the basis of the defect density D0lower of the lower interconnect and the critical area Ecalower of the lower interconnect, a yield Ylower of the lower interconnect can be calculated in accordance with a relationship formula, Ylower=exp(−(D0lower×Ecalower)), obtained from the aforementioned Formula 5-1.

Next, a yield Ychain of the via chain on the test chip of FIG. 11A is obtained through measurement evaluation.

Then, on the basis of the thus calculated yields Ychain, Yupper and Ylower, a yield Yvia of the vias is calculated in accordance with the aforementioned Formula 5-2, namely, Yvia=Ychain/(Ylower×Yupper). In this manner, the yield of the vias alone can be calculated by dividing the yield calculated with respect to the via chain by the yields of the lower interconnect and the upper interconnect.

Subsequently, on the basis of the calculated yield Yvia and critical area Ecavia, a defect density D0via of the vias is calculated in accordance with the aforementioned Formula 5-3, namely, D0via=−In(Yvia)/Ecavia.

As described so far, according to Embodiment 3, the yield of vias alone can be separately obtained on the basis of the yield of a via chain widely used for via yield calculation. Therefore, a step affecting the yield of actual products can be accurately extracted, and hence, selection of a method for improving the yield or the like can be rapidly performed by utilizing the result of the extraction.

The yield calculation method of this embodiment can be practiced by using a yield calculation apparatus similar to that of Embodiment 1. In other words, an apparatus for practicing the yield calculation method of this embodiment includes, for example, a storage device for storing various data necessary for practicing the method and a CPU for executing the method and outputting a result of the execution.

1. A pattern analysis method for an electronic device including a plurality of vias, comprising the step of:
calculating a critical area of one via out of said plurality of vias on the basis of sizes of said plurality of vias, sizes of defects causing random defect failures of said plurality of vias and a distance from said one via to another adjacent via.

2. The pattern analysis method of claim 1,
wherein the step of calculating a critical area of one via includes a sub-step of selecting said one via from said plurality of vias, calculating a distance from said one via to another adjacent via, and defining a region from said one via to a half of said calculated distance as a space region of said one via.

3. The pattern analysis method of claim 1,
wherein the step of calculating a critical area of one via includes a sub-step of selecting said one via from said plurality of vias, calculating a distance from said one via to another adjacent via in each of four regions partitioned by four half-lines starting from said one via, and defining a region from said one via to a half of said calculated distance as a space region of a quarter of said one via corresponding to each of said four regions.

4. A yield calculation method using the pattern analysis method of claim 1, comprising the step of:
calculating a yield of said plurality of vias on the basis of said critical area obtained by the pattern analysis method and a density and a distribution of said defects previously obtained.

5. A yield calculation method comprising the steps of:
calculating critical areas of a plurality of vias included in an electronic device; and
calculating a yield Y of said plurality of vias in accordance with the following formula:
Y=exp(−Cav·D0)
wherein Cav is said critical areas of said plurality of vias and D0 is a total number per unit area of defects with sizes possibly causing failures of said plurality of vias.

6. The yield calculation method of claim 5,
wherein the step of calculating critical areas includes a sub-step of calculating a critical area of one via out of said plurality of vias on the basis of sizes of said plurality of vias, said sizes of defects possibly causing random defect failures of said plurality of vias and a distance from said one via to another adjacent via.

7. The yield calculation method of claim 5,
wherein the step of calculating critical areas includes a sub-step of calculating, as said critical areas of said plurality of vias, two kinds of open critical areas at least including a hard open critical area and a soft open critical area.

8. A pattern analysis apparatus comprising:
a storage device for storing, as CAD data, mask data corresponding to pattern layout data with respect to which a critical area is to be obtained;
operating means for executing the pattern analysis method of claim 1 by using said mask data read from said storage device; and
outputting means for outputting information of said critical area obtained by said operating means.

9. A yield calculation apparatus comprising:
a storage device for storing, as CAD data, mask data corresponding to pattern layout data with respect to which a critical area is to be obtained;
operating means for executing the yield calculation method of claim 4 by using said mask data read from said storage device; and
outputting means for outputting information of said yield obtained by said operating means.

10. A yield calculation apparatus comprising:
a storage device for storing, as CAD data, mask data corresponding to pattern layout data with respect to which a critical area is to be obtained;
operating means for executing the yield calculation method of claim 5 by using said mask data read from said storage device; and
outputting means for outputting information of said yield obtained by said operating means.

11. A yield calculation method for calculating a yield of vias on the basis of an evaluation result obtained by using a test chip having a via chain composed of a lower interconnect, an upper interconnect and said vias for connecting said lower interconnect and said upper interconnect to each other, comprising the step of:
calculating a yield of said vias alone by dividing a yield calculated on said via chain by yields of said lower interconnect and said upper interconnect.

12. The yield calculation method of claim 11, further comprising the steps of:
calculating critical areas of said vias by using layout data of said test chip; and
calculating a density of defects causing random defect failures of said vias on the basis of said yield of said vias calculated in the step of calculating a yield and said critical areas of said vias calculated in the step of calculating critical areas.

13. A pattern analysis method for an electronic device including a via, comprising the step of:
calculating, as a critical area of said via, two or more kinds of open critical areas including at least a hard open critical area and a soft open critical area.

14. The pattern analysis method of claim 13,
wherein the step of calculating two or more kinds of open critical areas includes a sub-step of defining a pattern region that has a center according to a center of said via and has a specific homothetic ratio to said via as a hard open critical area calculation via region and defining a region of said via excluding said hard open critical area calculation via region as a soft open critical area calculation via region.

15. The pattern analysis method of claim 13,
wherein the step of calculating two or more kinds of open critical areas includes a sub-step of determining that a hard open failure occurs when a defect that may cause a random defect failure and has a dimension with a value not smaller than a product of a dimension of said via and a given value is present in said hard open critical area calculation via region and determining that a soft open failure occurs when said defect is present in said soft open critical area calculation via region but is not present in said hard open critical area calculation via region.
